(19) United States
(12) Patent Application Publication
(10) Pub. No.: US 2005/0212823 A1
(43) Pub. Date: Sep. 29, 2005

(54) System, method and software for intelligent zooming in a user interface

(76) Inventors: Robert T. Uthe, Morrisville, NC (US); John P. Whitfield, Cary, NC (US)

Correspondence Address: COATS & BENNETT, PLLC, P O BOX 5, RALEIGH, NC, 27602, US

(21) Appl. No.: 10/811,541

(22) Filed: Mar. 29, 2004

(51) Int. Cl. G09G 5/00; G06K 9/62; G06K 9/74

(52) U.S. Cl. 345/660; 382/224; 382/225; 382/228; 345/661

(57) ABSTRACT

An intelligent zoom on the display of a visualization of resources identifies resources of interest by comparing attributes associated with the resources to predetermined criteria. A future display area is calculated, zoomed from the current display by an initial factor. The future display area is positioned to include the largest possible number of resources of interest, and the view in the future display area replaces the current display. In one embodiment, the future display area continues to zoom and position such that resources of interest are proximate at least two edges of the future display area. Resources of interest may be weighted by priority.

### BACKGROUND

The present invention relates generally to the field of computers and in particular to an intelligent zooming system for a user interface.

As computers, and their associated networks and other resources, become increasingly sophisticated, increasingly powerful applications are deployed that manage, process, and analyze increasingly large sets of data. One well-known method of presenting large amounts of data to a user in a comprehensible format, particularly where interrelationships between data elements or resources convey information, is by a graphic visualization of the resources and their interconnection. Examples include geographic and topographic maps; electronic, mechanical, or plumbing schematic diagrams; tree maps, including tree structures such as software module interconnection diagrams; information technology resources such as network maps; and the like.

To be useful, such visualizations of resources must provide the user with tools to navigate through the often very large graphic representations of resources, such as by the well-known operations of zooming in and out, and panning the currently displayed view over the visualization. A variety of tools for both zooming and panning are an integral part of many Graphic User Interface (GUI) based operating systems, and are well known in the art. Typically, buttons or preset percentages are provided that allow the user to zoom in and out relative to the center of the currently displayed view. Panning functionality may be provided by buttons that move the displayed view by a predetermined amount in the selected direction, or by vertical and/or horizontal slider bars along the edges of the display window. Another known navigation technique that combines zooming with panning allows the user to draw a “rubber band” box around a desired portion of the visualization, which is then zoomed to occupy the full display. None of these tools for zooming and/or panning exhibit any intelligence in terms of providing a meaningful view or display of the visualization based on the underlying data.

### SUMMARY

The present invention relates to a method of zooming in or out a current display of a plurality of resources, each resource having zero or more attributes and each said resource being a resource of interest if it has at least one attribute that matches predetermined criteria. The method comprises computing a future display area zoomed in or out from the current display by a predetermined factor, positioning the future display area to include the largest possible number of resources of interest, and replacing the current display with a view of the future display area.

### BRIEF DESCRIPTION OF DRAWINGS

FIG. 1 is a functional block diagram of a computer system.

FIG. 2 is a prior art view of a display of a visualization of resources.

FIG. 3 depicts several intelligent zooming future display areas on the display of FIG. 2.

FIG. 4 a fully zoomed display of a resource of interest.

FIG. 5 is a flow diagram depicting a method of intelligently zooming a display of resources.

### DETAILED DESCRIPTION

The present invention relates to a method of intelligent zooming in a display of a visualization of resources. The intelligence derives from considering the values of attributes associated with the resources in determining the position and, in one embodiment, the zoom factor of a zoomed display. According to the present invention, the display quickly zooms to display the portion of the visualization that includes the greatest number of resources of interest to the user, as determined by the value of the resources' attributes. The present invention also relates to software and a computer system executing the intelligent zooming.

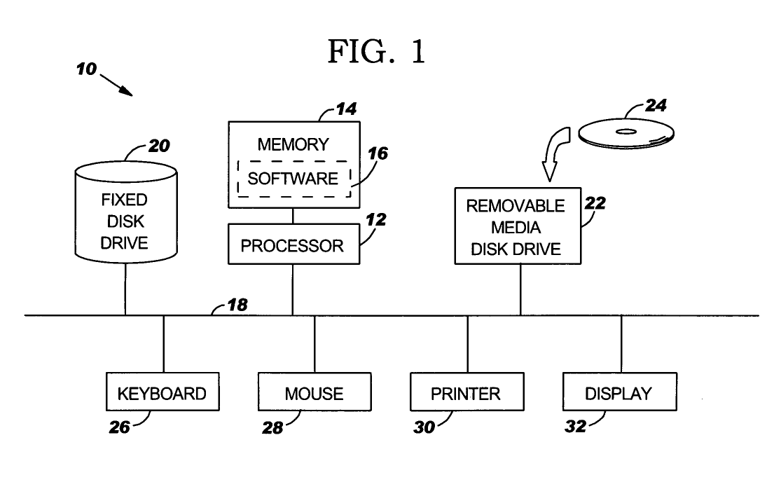

FIG. 1 depicts a functional block diagram of a representative computer system, indicated generally by the numeral 10. The computer system 10 includes a processor 12 capable of executing stored instructions. Connected to the processor 12 is memory 14 that, in operation, stores software 16. Software 16 may include, in addition to operating systems and the like, one or more applications that display a visualization of resources. An information technology network map is one example of an application that displays a visualization of resources.

The processor 12 is connected to a bus 18, to which are connected a variety of data storage devices and input and output devices. The bus 18 may comprise, for example, a Peripheral Component Interconnect (PCI) bus, or other standard buses known in the art, such as Accelerated Graphics Port (AGP), Industry Standard Architecture (ISA), Extended Industry Standard Architecture (EISA), the Micro Channel bus from IBM, the S-Bus from Sun Microsystems, or the like. A fixed disk drive 20 containing a computer-readable medium, from which software 16 may be loaded into memory 14, may be attached to the bus 18. Additionally, a removable media disk drive 22 that receives removable computer-readable media 24 may be attached to the bus 18. The removable media 24 may comprise a floppy disk, a CD-ROM or DVD-ROM, a magnetic tape, high-capacity removable media, or the like. Removable media 24 may contain a variety of digital data, and in particular may contain software 16, including operating system software such as UNIX, AIX, LINUX, Windows or the like, as well known in the art. Software 16 may also comprise applications that, in operation, display data to a user as a visualization of resources. The software 16 may be copied from the removable media 24 to the fixed disk drive 20, and subsequently loaded into memory 14 from the fixed disk drive 20. Alternatively, the software 16 may be loaded directly from the removable media 24 into the memory 14.

Also connected to the bus 18 are input devices such as a keyboard 26 and a mouse 28, as well known in the art. The computer system 10 may additionally include output devices such as a printer 30. In particular, the computer system 10 includes a display device 32. Display device 32 may comprise a traditional Cathode Ray Tube (CRT) monitor, or a flat-panel display such as a Liquid Crystal Display (LCD), Organic Light Emitting Diodes (OLED), Field Emission Display (FED) or the like. The display may be 2- or 3-dimensional, the latter either via the use of special glasses or goggles, or a laser holographic display or the like. The display device 32 may additionally comprise a Heads-Up Display (HUD), Virtual Reality (VR) goggles or headset, or the like. In general, the display device 32 may comprise any computer display technology, now known or developed in the future, through which a visualization of resources may be presented to a user.

Those of skill in the art will readily recognize that the computer system 10 of FIG. 1 is representative only, and may, in any given implementation or embodiment, omit one or more functional blocks, and/or include additional functionality. The depiction of a computer system 10 and accompanying description do not limit the scope of the present invention, which may be advantageously utilized on any computer system capable of displaying data to one or more users as a visualization of resources.

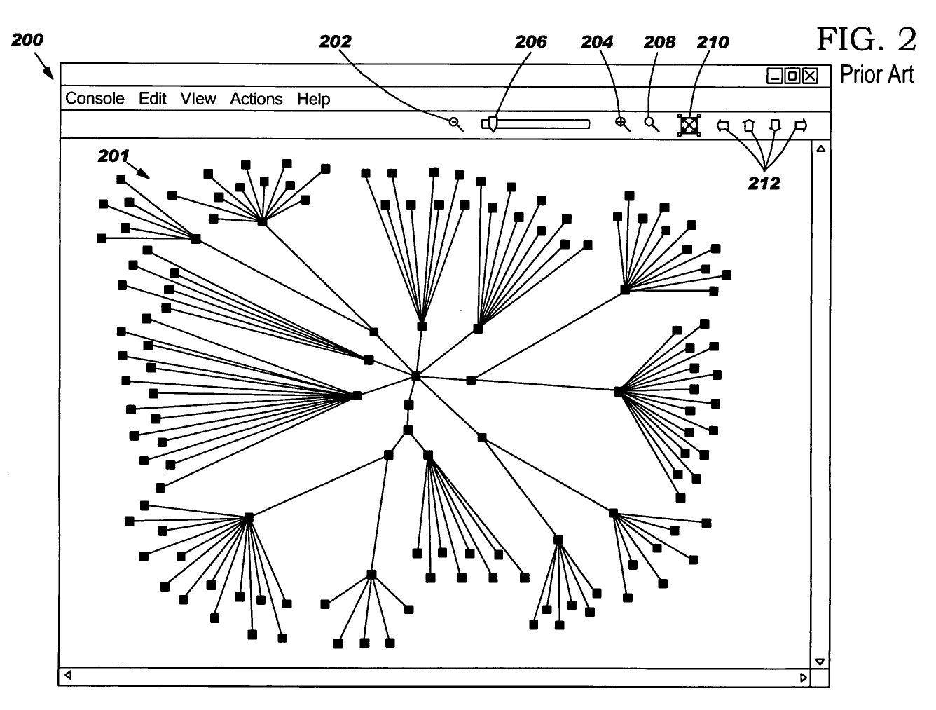

In operation, software 16 executing on the computer system 10 displays a visualization of resources to a user via the display device 32. FIG. 2 depicts a visualization 201 of resources, such as, in this example, computers, servers, routers, communication links, and other elements of an Information Technology (IT) system. The visualization 201 of the system, or portions thereof, are displayed in a GUI window 200. In the visualization 201, a plurality of resources and their interconnections are represented, when displayed, as graphical elements. Each resource may have associated with it any number of attributes, each attribute having a value. The attributes may include, for example, an identifier, and/or information about the resource such as its type, function, capacity, speed, or the like. Additional attributes may reflect operational status, such as active or inactive, normal, critical or failed, or the like. Attributes may also assume numerical values, such as a time stamp, bandwidth, count of throughput, or number of downstream resources, or the like.

The GUI window 200 provides a variety of methods to navigate the visualization 201, as known in the art. For example, zoom out button 202 and zoom in button 204 will typically zoom the display out or in, respectively, by a fixed, predetermined factor. Slider 206 disposed between zoom buttons 202, 204 may allow for a dynamic zooming operation when selected by a cursor and moved within its track. These methods of zooming typically do not include panning functions, and zoom the display in and out while maintaining the current center of the view presented to the user. Button 208 allows a user to draw a dynamic “rubber band” window, which the user may draw around a group of resources of interest, causing the display to zoom in to the degree and at the position indicted by the user. Button 210 provides a “zoom to fit” capability, which may zoom the display out to the extent necessary to display the entire visualization 201 (i.e., the view depicted in FIG. 2). Directional icon buttons 212 may allow the user to pan the currently displayed view over the visualization 201 in the indicated directions.

None of these prior art zooming and panning operations take into consideration any attributes of the resources that comprise the visualization 201. While they provide a user with a means to zoom and pan the display to focus on resources of interest, typically the user must go through several such operations to arrive at a display that is most useful for his or her purposes. According to the present invention, intelligent zooming is achieved by successively altering both the size and position of the displayed view of the visualization 201 based on the attributes of the displayed resources.

According to the present invention, a level of interest is established for each resource, depending on the value of one or more attributes. For example, a resource having a STATUS attribute with a value of CRITICAL or FAILED may be of greater interest to a user than similar resources having a STATUS attribute with the value NORMAL. As another example, resources with an updated-timestamp attribute having a value less than five minutes older than the current time may be of higher interest than other resources. As yet another example, resources with attributes reflecting high load, throughput, number of downstream resources, or the like may be of heightened interest to a user. In general, any attribute may be inspected to determine the relative level interest of a resource. Additionally, the value of an attribute may determine the associated resource's level of interest as the result of any logical or mathematical operation, for example, the boolean match of a flag, a numeric value meeting or exceeding a threshold, a numeric value falling within a range, or the like.

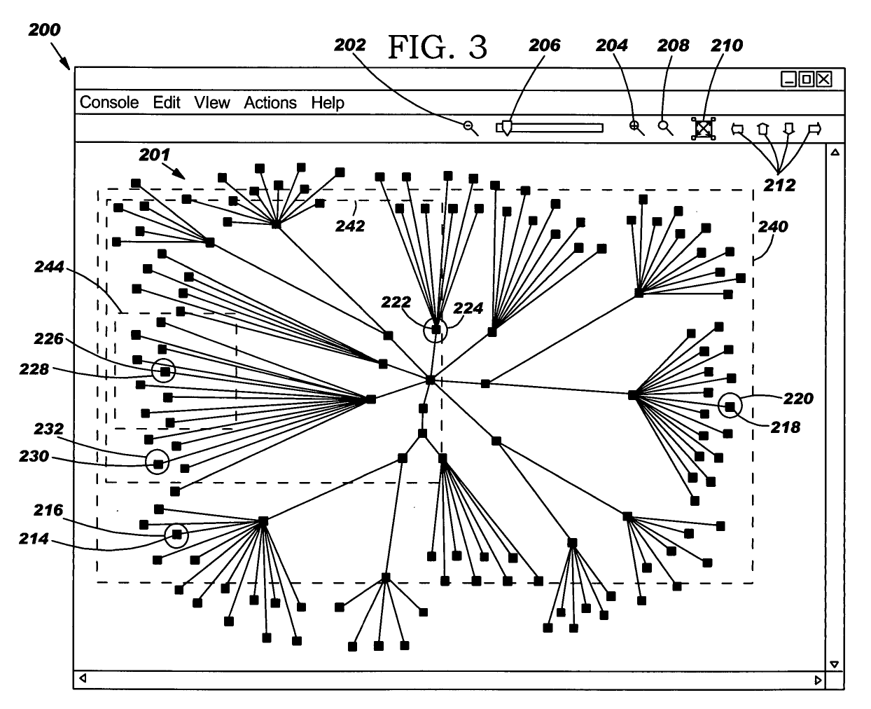

Both the attributes consulted to determine the level of interest of resources and the value of those attributes may be predetermined or may be supplied by the user. FIG. 3 depicts the visualization 201 displayed in GUI window 200, wherein in certain resources 214, 218, 222, 226 and 230 have a higher level of interest than other resources in the visualization 201, as the result of the value of one or more attributes associated with them. These resources 214, 218, 222, 226, 230 are preferably visually distinguished, such as by being displayed in a different color, by a blinking display, or by being identified by an associated icon, such as the surrounding circles 216, 220, 224, 228, 232, respectively. The circles 216, 220, 224, 228, 232 are illustrative only, and may in general comprise any shape or size. It is probable that a user viewing the visualization 201 will want to view or inspect in detail the resources 214, 218, 222, 226, 230 indicated as being of interest—that is, the user likely desires to zoom and pan the display of GUI window 200 over the visualization 201 to focus on all or some of these resources 214, 218, 222, 226, 230.

According to the present invention, in response to a zoom command, the display both zooms and pans so as to present to the user a view of the visualization 201 including resources of interest. This process is described with reference to FIG. 3. Upon a zoom-in command (which may be entered by a graphic icon such as zoom buttons 202, 204, a unique keystroke, a control key and mouse button combination, or other input as well known in the art), the application displaying the visualization 201 calculates a future display area, depicted by the dashed-line box 240 in FIG. 3. The future display area 240 is zoomed in from the current display by an initial factor, such as 120% (i.e., the magnification when the future display area 240 is substituted for the current display would be 120% of the current display). The future display area 240 is then positioned within the visualization 201 to encompass as many resources of interest as possible, which in this example includes all resources of interest 214, 218, 222, 226 and 230. Once the future display area 240 is calculated and positioned, the view of the visualization 201 within the future display area 240 is substituted for the current display—that is, the current display is “zoomed in” to the extent and position of the future display area 240. Note that the dashed-line border of the future display area 240 is not actually visible to the user—it is depicted in FIG. 3 for illustrative purposes only. The user would experience only an instantaneous zoom from the display depicted in FIG. 3 to a display zoomed and positioned as indicated by the boundary box of the future display area 240.

A second zoom-in operation similarly causes the application displaying a view of the visualization 201 (zoomed to the extent and position indicated by 240) to calculate a future display area 242 having a particular size, resulting from an initial zoom factor. The future display area 242 is positioned over the visualization 201 so as to encompass the maximum number of resources of interest—in this example, resources 222, 226 and 230. The view within the future display area 242 is then substituted for the current view (again, the boundary box of the future display area 242 is not actually displayed to the user).

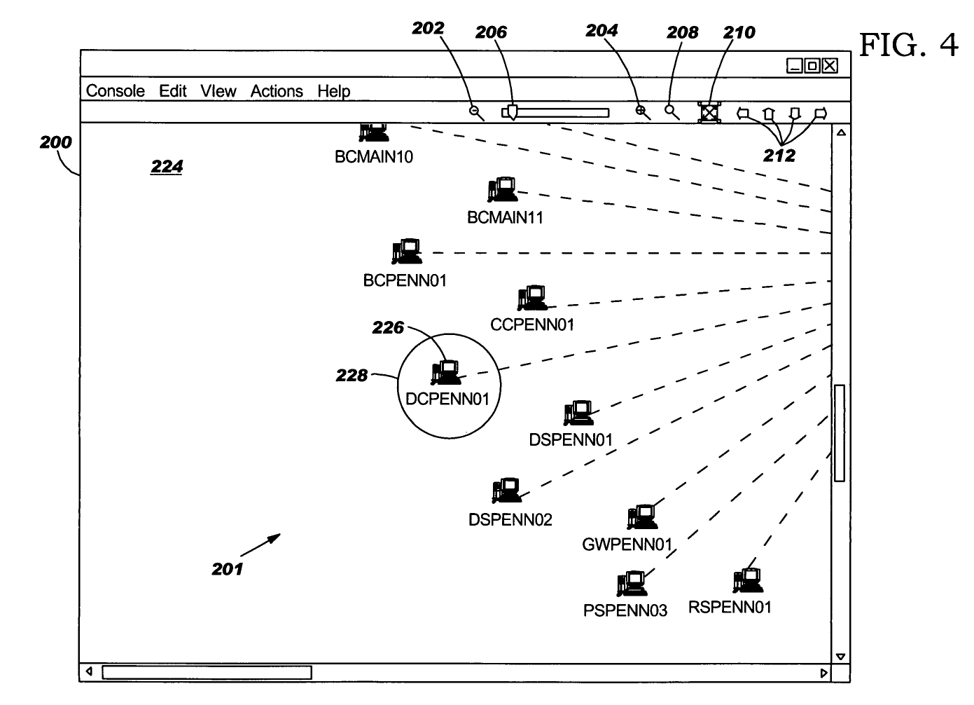

The intelligent zooming process continues, both zooming in and positioning the zoomed-in display over the greatest number of resources of interest, as indicated by resource attribute values. At some point, a zoom-in command may cause the generation of a future display area, such as 244, that is incapable of simultaneously encompassing more than one resource of interest 226. In this case, the future display area 244 may be positioned such that the resource of interest 226 is centered, resulting in the display, following the intelligent zoom operation, depicted in FIG. 4. As shown in FIG. 4, and as well known in the art, by zooming in on resources 226, more information, such as the attribute values that flag the resource 226 as being of interest, may be displayed to a user.

The purpose of zooming in by an initial factor to generate a future display area 240, 242, 244 is to avoid small, incremental zooms when several widely-dispersed resources of interest are displayed in a view of the visualization 201. The initial zoom factor may be predetermined, or alternatively may be selected by the user. A default value is preferably in the range from 115% to 130% of magnification with respect to the currently displayed view, and is more preferably about 120%.

According to one embodiment of the present invention, as illustrated by one example in FIG. 3, following the zoom by an initial factor, and positioning of a future display area 242 to encompass the greatest number of resources of interest, the bounding box defining the future display area 242 continues to shrink,—i.e., the future view continues to zoom or magnify—until resources of interest 222, 230 are positioned proximate at least two edges of the future display area 242. This ensures the maximum level of magnification of the zoomed view, while still containing all of the identified resources of interest 222, 228, 230. In this example, an initial zoom factor would have generated a larger bounding box for the future display area 242 (zooming in from a display of the view of area 240). The future display area 242 would then have been positioned to include resources of interest 222, 228 and 230. The box bounding the future display area 242 then continued to shrink, until it reached resource 222 adjacent one edge, and resource 230 adjacent a second edge. In this manner, when the view of the future display area 242 replaces the current view of the visualization 201, the resources of interest 222, 228 and 230 will be displayed at maximum magnification, with some resources not of interest omitted from the view.

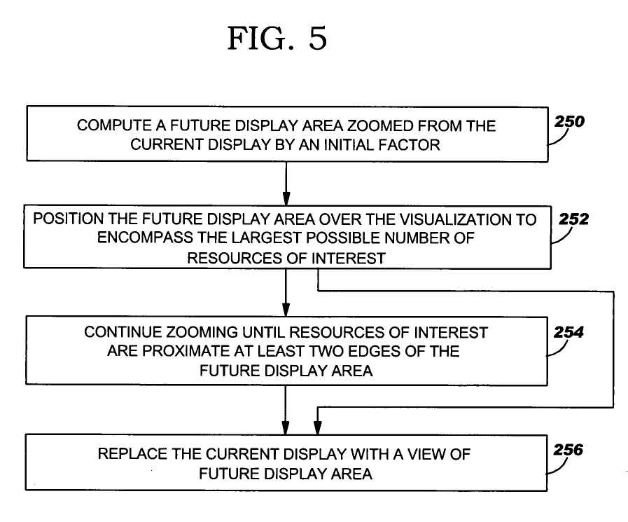

A method of intelligent zooming according to the present invention is depicted in flow diagram form in FIG. 5. A future display area is computed by zooming from the currently displayed view of a visualization by an initial factor at step 250. The future display area is then positioned over the visualization so as to encompass the largest possible number of resources of interest, as determined by having attributes whose values match predetermined criteria, at step 252. In one embodiment, the future display area continues to zoom until resources of interest are proximate at least two edges of the future display area at step 254. In another embodiment step 254 is bypassed. When the future display area is zoomed and positioned, the current display is replaced with the view of the future display area.

Although described herein with respect to zooming in, the present invention applies equally to zooming out. A future display area is calculated that zooms out from the current display by an initial factor. The initial zoom factor may be predetermined, or may be specified by the user. The initial zoom factor is preferably in the range of about 70% to about 85%, and is most preferably about 85%. The future display area is then positioned over the visualization 201 such that it encompasses the maximum number of resources of interest, as determined by attribute values. In one embodiment, the positioning of the future display area is constrained to include the currently displayed area. In this embodiment, the zoom out operation comports with a user's intuitive expectation that a zoomed out view will include the portion of the visualization 201 displayed in the current view. Once the future display area is zoomed and positioned, the view within the future display area replaces the current view.

In one embodiment, the intelligent zooming according to the present invention is mapped to the buttons, keystroke and mouse clicks that control conventional zooming. That is, intelligent zooming “replaces” conventional zooming. In another embodiment, intelligent zooming according to the present invention is mapped to alternate buttons, keystroke and/or mouse clicks, with conventional zooming and panning available via the inputs associated with it. In one embodiment, the intelligent zooming of the present invention dominates unless and until there are no resources of interest within a view, in which case zooming and panning functions default to their conventional functionality.

The initial zoom factor, whether or not zooming continues until resources of interest are proximate at least two edges of a future display area, the attributes to be inspected to determine whether a resource is of interest or not, and the value of the attributes that trigger “of interest” status may all be predetermined. Alternatively, a user may select any or all of these parameters.

In one embodiment of the present invention, different degrees of priority may exist among resources of interest. For example, a resource having an attribute indicating it is significant to the operation of the entire IT system may be considered a higher priority than a similar resource having an attribute indicating it is significant to the operation of a subset of the IT system. In this case, the higher priority resource may be weighted more than the lower priority resource, although both resources are of interest as compared to other resources in the visualization 201. This weight may influence the zoom level, positioning, or both, of a future display area in an intelligent zoom operation.

As used herein the term “visualization” refers to a virtual graphic representation of a plurality of resources and the interconnections or interrelationships between the resources. The entire visualization 201 may be displayed on the display device 32 of a computer system 10, when the display is sufficiently zoomed out (e.g., “zoom to fit”). As a user zooms in, a portion of the visualization 201 is magnified in the display, referred to herein as a “view” of the visualization 201, and other portions are omitted from display. Non-displayed portions of the visualization 201 exist as a virtual graphic data structure, and non-displayed views of the visualization 201 may be calculated according to the present invention for future display, when the views are not actually displayed on the display device 32.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of zooming in/out a current display of a visualization of resources, each said resource having zero or more attributes, and each resource being a resource of interest if it has at least one attribute that matches predetermined criteria, comprising:
computing a future display area zoomed in/out from said current display by an initial factor;
positioning said future display area over said visualization to include the largest possible number of resources of interest; and
replacing said current display with a view of said future display area.

2. The method of claim 1 further comprising, following positioning said future display area, further zooming in/out said future display area until resources of interest are proximate at least two edges of said future display area.

3. The method of claim 1 wherein said initial factor is in the range from about 115% to about 130% for a zoom in, and in the range from about 70% to about 85% for a zoom out.

4. The method of claim 3 wherein said initial factor is about 120% for a zoom in, and about 80% for a zoom out.

5. The method of claim 1 wherein said initial factor is predetermined.

6. The method of claim 1 wherein said initial factor is specified by a user.

7. The method of claim 1 wherein said resources of interest are visually distinguished in said current display.

8. The method of claim 7 wherein said resources of interest are visually distinguished by displaying indicia of interest associated with said resources.

9. The method of claim 1 wherein said attributes that match predetermined criteria are predetermined.

10. The method of claim 1 wherein said attributes that match predetermined criteria are selected by a user.

11. The method of claim 1 wherein said resources of interest have different degrees of priority, wherein at least one said resource of interest has a higher priority than at least one other resource of interest.

12. The method of claim 11 wherein positioning said future display area to include the largest possible number of resources of interest comprises positioning said future display area to include the largest possible number of resources having said higher priority.

13. The method of claim 1 wherein, if said future display area cannot include more than one resource of interest, positioning said future display area to include the largest possible number of resources of interest comprises positioning said future display area such that a single resource of interest is centered in said future display area.

14. A method of zooming in a current display of a visualization of resources, each said resource having zero or more attributes, and each resource being a resource of interest if it has at least one attribute that matches predetermined criteria, comprising:
computing a future display area zoomed in from said current display by an initial factor;
positioning said future display area over said visualization to encompass the largest possible number of resources of interest;
if the largest possible number of resources of interest that said future display area can encompass is one, positioning said future display area such that said one resource of interest is centered in said future display area; and
replacing said current display with a view of said future display area.

15. The method of claim 17 further comprising, prior to replacing said current display:
if said largest possible number of resources of interest that said future display area can encompass is at least two, further zooming and positioning said future display area such that a resource of interest is proximate at least two edges of said future display area.

16. A computer system, comprising:
a display device;
memory; and
a processor operatively connected to said display device and said memory, for executing code operative to produce a current display on said display device depicting a visualization of resources, each said resource having zero or more attributes, and each said resource being a resource of interest if it has at least one attribute that matches predetermined criteria, said processor operative to perform the steps of:
computing a future display area zoomed in/out from said current display by an initial factor;
positioning said future display area over said visualization to include the largest possible number of resources of interest; and
replacing said current display with a view of said future display area.

17. The computer system of claim 16 wherein said processor further performs the step of, prior to replacing said current display, further zooming and positioning said future display area such that a resource of interest is proximate at least two edges of said future display area.

18. A computer-readable medium that stores computer-executable process steps for zooming in/out a current display of a visualization of resources, each said resource having zero or more attributes, and each said resource being a resource of interest if it has at least one attribute that matches predetermined criteria, said computer-executable process steps causing a computer to perform the steps of:
computing a future display area zoomed in/out from said current display by an initial factor;
positioning said future display area over said visualization to include the largest possible number of resource of interest; and
replacing said current display with a view of said future display area.

19. The computer-readable medium of claim 18, said computer-executable process steps further causing a computer to perform the step of, prior to replacing said current display, further zooming and positioning said future display area such that a resource of interest is proximate at least two edges of said future display area.
